(19) United States
(12) Patent Application Publication
(10) Pub. No.: US 2024/0017220 A1
(43) Pub. Date: Jan. 18, 2024

(54) DILUTION STATION

(71) Applicant: Diversey, Inc., Fort Mill, SC (US)

(72) Inventors: Decio Rondon Silva, Amsterdam (NL); Jan Veening, IJsselstein (NL); Joachim Gerrit Ramp, Waddinxveen (NL); Arnoud Gengler, De Schiphorst (NL)

(21) Appl. No.: 17/767,703

(22) PCT Filed: Oct. 9, 2020
(86) PCT No.: PCT/US20/55142

§ 371 Date: Apr. 8, 2022

Related U.S. Application Data
(60) Provisional application No. 62/914,044, filed on Oct. 11, 2019.

(51) Int. Cl. B01F 23/40; C02F 1/461; C02F 1/68; C02F 1/00; C02F 1/467; B01F 23/70; B01F 23/45; B01F 33/84

(52) U.S. Cl. CPC B01F 23/483; C02F 1/46104; C02F 1/686; C02F 1/008; C02F 1/4672; B01F 23/70; B01F 23/45; B01F 33/84; B01F 2101/4505

(57) ABSTRACT

A dosing system includes a dispensing apparatus that receives first and second fluids from respective input sources. The first fluid is modified by an electrolytic cell assembly to produce an output fluid, and the second fluid flows through the electrolytic cell assembly or bypasses the electrolytic cell assembly. The dispensing apparatus includes a cartridge system supporting chemical cartridges having a concentrated solution and a mechanism to dispense the solution. At least two chemical cartridges with different concentrated solutions, and each chemical cartridge selectively fluidly communicates with the output fluid and the second fluid. The dispensing apparatus also includes an interface and a controller programmed to perform instructions including receiving a request from the interface, mixing the concentrated solutions and the first or second fluid input sources, and dispensing a product defining a dilution including the first and second fluid input sources and the chemical solutions.

### BACKGROUND

The present invention relates to localized cleaning solution production and dosing systems at a customer site.

Cleaning solutions are often produced and dispensed via dilution and dispensing systems that turn concentrated products into use solutions. One example of such dilution and dispensing systems includes portion-dosed systems that separately provide a fixed quantity of chemical concentrate (e.g., a fixed aliquot of liquid or powder provided in a sachet, a tablet, etc.) and a fixed quantity of diluent (e.g., a fixed aliquot of water supplied in a bucket, a spray bottle, etc.) which are then manually combined by a user to produce the use solution. Similarly, pump-top bottles may be utilized to deliver a fixed aliquot of liquid concentrate into a container holding a fixed aliquot of diluent to produce the use solution. Venturi-based dilution and dispensing systems direct a diluent through a Venturi system which utilizes a resultant negative pressure to draw up a concentrate from a container, which is then mixed with the diluent to produce the use solution. Such Venturi-based systems rely on tightly controlled diluent pressures and flow rates to maintain accurate mixing ratios. Other systems utilize electrically-driven dosing pumps (e.g., membrane pumps, peristaltic pumps, gear pumps, etc.) to supply a known quantity of concentrate to a known quantity of diluent.

### SUMMARY OF THE INVENTION

The present invention provides, in one aspect, a dosing system including a dispensing apparatus that receives first and second fluids from respective input sources. The first fluid is modified by an electrolytic cell assembly to produce an output fluid comprising one or more of an alkaline output fluid, a chlorine output fluid, and a hydrogen peroxide fluid. The second fluid flows through the electrolytic cell assembly or bypasses the electrolytic cell assembly. The dispensing apparatus includes a cartridge system configured to removably support a plurality of chemical cartridges. Each chemical cartridge has a concentrated solution and a mechanism that dispenses the concentrated solution contained in the chemical cartridge. At least two of the plurality of chemical cartridges has different concentrated solutions, and each chemical cartridge is selectively in fluid communication with one or both of the output fluid and the second fluid. The dispensing apparatus also includes an interface that receives a request for a chemical solution supported by the dosing system. The dispensing apparatus further includes a controller with a processor that is programmed to perform instructions stored in a memory. The instructions include receiving the request from the interface, mixing a predetermined ratio of at least one of the concentrated solutions from the chemical cartridges and one or both of the output fluid and the second fluid, and dispensing a product defining a dilution including one or both of the output fluid and the second fluid and one or more of the chemical solutions supported by the chemical cartridges. The dilution conforms to the request received by the interface.

The present invention provides, in another aspect, a method of dispensing a chemical product from a dosing system. The method includes removably inserting a first cartridge containing a first concentrated solution into an installed position in the dosing system. The method also includes removably inserting a second cartridge containing a second concentrated solution into another installed position in the dosing system, the second concentrated solution being different from the first concentrated solution. The method also includes receiving, via a user interface of the dosing system, a first request for a first chemical solution supported by the dosing system. The method also includes drawing concentrated solution from the first cartridge or the second cartridge based at least in part on the first request. The method also includes supplying one of at least two different diluents by the dosing system based at least in part on the first request. The method also includes mixing a predetermined ratio of the concentrated solution drawn from the first cartridge or the second cartridge with the diluent supplied based at least in part on the first request. The method further includes dispensing a first product defining a first dilution including the drawn concentrated solution and the supplied diluent based at least in part on the first request, with the first dilution conforming to the first request received by the interface. The method also includes receiving, via the user interface of the dosing system, a second request for a second chemical solution supported by the dosing system, with the second chemical solution being different from the first chemical solution. The method includes drawing concentrated solution from the first cartridge or the second cartridge based at least in part on the second request. The method further includes supplying one of the at least two different diluents by the dosing system based at least in part on the second request, and mixing a predetermined ratio of the concentrated solution drawn from the first cartridge or the second cartridge with the diluent supplied based at least in part on the second request. The method further includes dispensing a second product defining a second dilution including the drawn concentrated solution and the supplied diluent based at least in part on the second request, with the second dilution conforming to the second request received by the interface.

The present invention provides, in another aspect, a dosing system including a dispensing apparatus that receives first and second fluids from respective input sources. The first fluid is modified by an electrolytic cell assembly to produce an output fluid comprising one or more of an alkaline output fluid, a chlorine output fluid, and a hydrogen peroxide fluid. The second fluid flows through the electrolytic cell assembly or bypasses the electrolytic cell assembly. The dispensing apparatus includes a cartridge system that supports a plurality of chemical cartridges, and each chemical cartridge has a concentrated solution. At least two of the plurality of chemical cartridges have different concentrated solutions, and each chemical cartridge is selectively in fluid communication with one or more of the output fluid and the second fluid. The dispensing apparatus also includes an interface that receives a request for a chemical solution supported by the dosing system. The dispensing apparatus includes a controller with a processor that is programmed to perform instructions stored in a memory. The instructions include receiving the request from the interface, mixing a predetermined ratio of one or more of the concentrated solutions from the chemical cartridges and one or more of the output fluid and the second fluid, and dispensing a product conforming to the request received by the interface. The dispensed product defines a dilution that includes one of a first concentration of chemical solution and a second concentration of chemical solution having a higher concentration than the first concentration of chemical solution.

Other features and aspects of the invention will become apparent by consideration of the following detailed description and accompanying drawings.

### BRIEF DESCRIPTION OF THE DRAWINGS

FIG. 1 is a schematic view of a dosing system embodying the invention.

FIG. 2 is a block diagram of a control system of the dosing system of FIG. 1.

FIG. 3 is a block diagram of a user interface module of the dosing system of FIG. 1.

FIG. 4 is a flow chart illustrating operation of the dosing system of FIG. 1.

FIG. 5 is an exemplary diagram illustrating different chemical solutions prepared and dispensed by the dosing system of FIG. 1.

FIG. 6 is another exemplary diagram illustrating different chemical solutions prepared and dispensed by the dosing system of FIG. 1.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

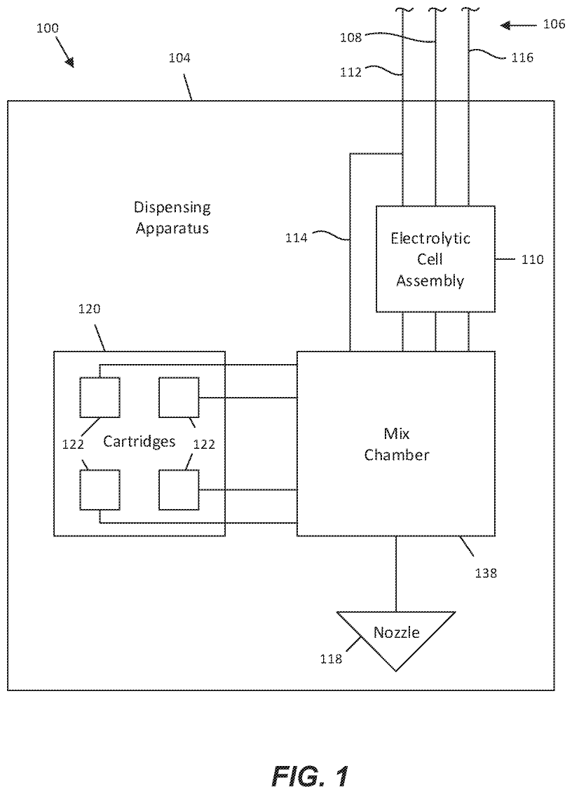

FIGS. 1-6 illustrate an exemplary dosing system 100 that produces one or more chemical solutions 102 locally or on-site at a use location. The dosing system 100 dispenses dosed quantities of the chemical solutions 102 via a dispensing apparatus 104 that mixes one or more concentrated solutions 124 with one or more diluents supplied from fluid input sources 106. The dosing system 100 is capable of producing different chemical solutions 102 on-demand in response to receiving a user request for the desired chemical solutions 102. By enabling on-demand, on-site production of the chemical solutions 102, the dosing system 100 reduces transportation, handling, and storage costs that would otherwise be associated with providing the chemical solutions 102 at the use location. The dosing system 100 further reduces the amount of packaging needed, and reduces the environmental impact of providing the chemical solutions 102 at the use location.

With reference to FIG. 1, the dispensing apparatus 104 is in fluid communication with the fluid input sources 106. It will be appreciated that the dosing system 100 can include a single fluid input source 106, or two or more fluid input sources 106. For purposes of description, the system 100 will be described in detail with regard to plural fluid input sources 106.

With reference to FIGS. 1, 2, 5, and 6, the dispensing apparatus 104 includes an electrolytic cell assembly 110 and at least one of the fluid input sources 106 is fluidly connected to the electrolytic cell assembly 110 to supply diluent to the electrolytic cell assembly 110. In one example, the electrolytic cell assembly 110 performs electro-chemical activation to produce an alkaline diluent fluid and/or a chlorine diluent fluid. In another example, the electrolytic cell assembly 110 performs electro-chemical activation to generate a highly concentrated hydrogen peroxide solution (e.g., 0.5-20%). An exemplary electrolytic cell assembly is described and illustrated in U.S. patent application Ser. No. 16/302,208, which was filed Nov. 16, 2018, and published Sep. 12, 2019, entitled “ALKALINE AND CHLORINE SOLUTIONS PRODUCED USING ELECTRO-CHEMICAL ACTIVATION”. Another exemplary electrolytic cell assembly is described and illustrated in U.S. patent application Ser. No. 16/478,157, which was filed Jul. 16, 2019, and published Dec. 5, 2019, entitled “NEUTRALIZATION IN ELECTRO-CHEMICAL ACTIVATION SYSTEMS”. The entire contents of each of these applications are hereby incorporated by reference.

With reference to FIG. 1, the fluid input sources 106 include a first fluid input source 108, a second fluid input source 112, and a third fluid input source 116. The first fluid input source 108 is in fluid communication with the dispensing apparatus 104 and with the cell assembly 110, and supplies a first diluent (e.g., water) to the cell assembly 110. The cell assembly 110 modifies or processes the first diluent to produce a first diluent fluid 117 that has one or both of an alkaline component and a chlorine component, or a hydrogen peroxide component (i.e. a modified diluent fluid).

The second fluid input source 112 is in fluid communication with the dispensing apparatus 104 and with the cell assembly 110. The second fluid input source 112 supplies a second diluent to the dispensing apparatus 104. As shown in FIG. 1, a bypass line 114 is fluidly connected to the second fluid input source 112 to circumvent or bypass the cell assembly 110. In some configurations of the dosing system 100, the second diluent flows through and is processed by the electrolytic cell assembly 110 to produce a second diluent fluid 119 that has one or both of an alkaline component and a chlorine component, or a hydrogen peroxide component (i.e. a modified diluent fluid) that is different from the first diluent fluid 117. In other configurations of the dosing system 100, the second diluent flows through the bypass line and defines an unmodified second diluent fluid (i.e. a second diluent fluid that is not modified by the cell assembly 110). The unmodified second diluent fluid may include softened water. It will be appreciated that a valve (not shown) can be positioned to control flow of the second diluent to the bypass line 114. Also, while FIG. 1 illustrates that the second diluent can flow through the bypass line 114, it will be appreciated that, in some constructions, the second diluent may pass through the cell assembly 110 without being modified (e.g., when the cell assembly 110 is ‘off’) such that the fluid downstream of the cell assembly 110 is an unmodified diluent fluid 119.

The third fluid input source 116 is in fluid communication with the dispensing apparatus 104 and with the cell assembly 110, and supplies a third diluent to the cell assembly 110. The cell assembly 110 modifies or processes the third diluent to produce a third diluent fluid 121 that has one or both of an alkaline component and a chlorine component, or a hydrogen peroxide component (i.e. a modified diluent fluid).

Referring back to FIG. 1, the dispensing apparatus 104 includes an outlet 118 (e.g., a nozzle) for dispensing fixed quantities of the chemical solutions 102 that are formed by mixing one or more concentrated solutions 124 with the desired diluent fluid 117, 119, 121 in a mix chamber 138. The outlet 118 can dispense the fixed quantities of chemical solutions into, for example, spray bottles, buckets, or larger containers used in, for instance, floor cleaning machines.

The mix chamber 138 is fluidly connected to the cell assembly 110, the bypass line 114, the outlet 118, and a cartridge system 120 of the system 100. As shown in FIG. 1, the cartridge system 120 is part of the dispensing apparatus 104, although the cartridge system 120 can be external to or separate from the dispensing apparatus 104. The cartridge system 120 removably supports chemical cartridges 122 that house the concentrated solutions 124. The cartridge system 120 includes cartridge receptacles that removably and replaceably receive the chemical cartridges 122 (i.e. in an installed position) within the dispensing apparatus 104. When installed into a cartridge receptacle, the chemical cartridge 122 can be selectively placed in fluid communication with the mix chamber 138.

With reference to FIGS. 1-3, each cartridge 122 contains a concentrated solution 124 and at least two of the cartridges 122 contain different concentrated solutions 124. As illustrated, the concentrated solutions 124 include highly concentrated cleaning formulations or cleaner concentrates 126 that are in powder or liquid form. Some of the concentrated solutions 124 in the dispensing apparatus 104 may also include additive solutions 128 (e.g., concentrated perfume solutions). In some embodiments, some or all of the concentrated solutions 124 (the cleaner concentrates 126, the additive solutions 128, or both) can be plant based or 100% biodegradable, or both.

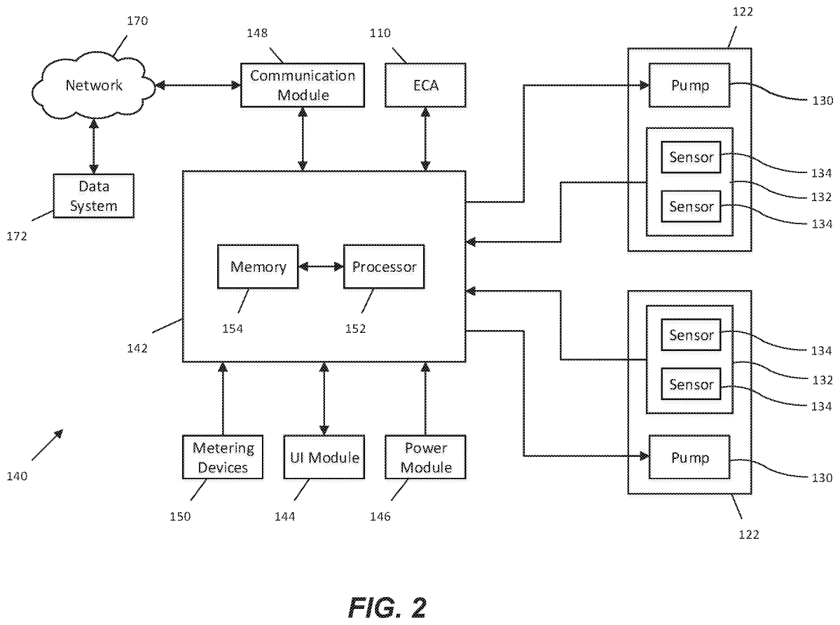

As shown in FIG. 2, each illustrated cartridge 122 also includes a pump 130 to supply the concentrated solution 124 from the cartridge 122 for mixing with a diluent fluid 117, 119, 121 in the mix chamber 138 when the desired concentrated solution 124 is selected. In the illustrated embodiment, each pump 130 is an electrically-powered gear pump 130, although other types of pumps (e.g., peristaltic pumps, membrane pumps, etc.) are also contemplated. In the illustrated embodiment, each pump 130 is included as an integral component of each respective cartridge 122.

In some constructions of the cartridge system 120, a pump may not be provided in or on one more of the cartridges 122. In these constructions, the cartridges that do not include a pump may be made as a rigid container (e.g., a bottle, etc.) or a collapsible container (e.g., a pouch, a bottle, a syringe, etc.). In embodiments where a cartridge does not include a pump, a quantity of concentrated solution may be drawn from the cartridge by a creating a pressure differential between the cartridge and the mix chamber 138 (e.g., via a central pumping system, a Venturi mixing valve, etc.). In embodiments where the cartridge is made as a collapsible container, a volume of the container can be manipulated to dispense fixed quantities of the concentrated solution contained therein.

With reference to FIG. 2, the illustrated embodiment includes a measuring system 132 that is associated with each cartridge 122 and that has a sensor 134 (e.g., one or more sensors 134 as shown in FIG. 2) for detecting properties or status of the cartridge 122. For example, the sensor(s) 134 may be a capacity sensor (e.g., an optical sensor) that detects the presence or absence of the concentrated solution 124 contained within the respective cartridge 122. In some embodiments, the capacity sensor may detect a quantity of concentrated solution 124 remaining within the cartridge 122 (in addition to or in lieu of detecting presence or absence). In some embodiments, the sensor 134 may be a metering sensor that detects a quantity of concentrated solution dispensed from the chemical cartridge 122 during a dispensing operation of the cartridge 122. It will be appreciated that the measuring system 132 may include different sensors 134 (e.g., a capacity sensor and a metering sensor).

Each cartridge 122 includes a housing 136 that defines a reservoir for containing the concentrated solution 124 and that supports the pump 130. In some embodiments, the housing 136 may also support the sensor(s) 134. The housing 136 can be made as a closed plastic container, or the housing 136 may take the form of a syringe-type design or a collapsible cylinder that contains the concentrated solution 124.

Each cartridge 122 is intended to be discarded when the supply of concentrated solution 124 becomes exhausted, and a replacement cartridge 122 can be installed into the corresponding cartridge receptacle. By replacing exhausted cartridges with filled cartridges (rather than re-filling exhausted cartridges), cross-contamination between different concentrated solutions 124 can be avoided within individual cartridges 122 and their associated fluid lines.

Referring to FIG. 1, the mix chamber 138 receives the diluent fluid 117, 119, 121—via the cell assembly 110 or the bypass line 114—and the concentrated solution 124 that are desired or selected based on the composition of the chemical solution 102 to be prepared. In some embodiments, the mix chamber 138 may receive only the selected or desired diluent fluid 117, 119, 121 (i.e. without receiving a concentrated solution 124). The diluent fluid-concentrated solution mixture or the selected diluent fluid alone (in either case, referred to as the chemical solution 102) are directed to the outlet 118. As shown in FIG. 1, the mix chamber 138 is disposed in the dispensing apparatus 104 upstream of the outlet 118. In some embodiments, the mix chamber 138 can be located at or in the outlet 118, in which case mixing of the diluent fluid 117, 119, 121 and the concentrated solutions can occur directly at the outlet 118.

In one example, a user (or an automated process) may request a first chemical solution 102 that is composed of a diluent fluid with a chlorine component (referred to as a ‘chlorinated diluent fluid’) and softened water. During preparation of the first chemical solution 102, the chlorinated diluent fluid 117, 121, which is generated by the electrolytic cell assembly 110 from the first fluid input source 108 or the third fluid input source 116, is mixed with the diluent fluid 119 from the second fluid input source 112 in the mix chamber 138, and then delivered to the outlet 118. In another example, a user may request a second chemical solution 102 that is composed of a diluent fluid with an alkaline component (referred to as an ‘alkalic diluent fluid’), a desired or selected cleaner concentrate 126, and/or a desired or selected additive solution 128. To prepare the second chemical solution 102, the alkalic diluent fluid 117, 121, which is generated by the electrolytic cell assembly 110 from the first fluid input source 108 or the third fluid input source 116, is mixed with the softened water from the second fluid input source 112, as well as the cleaner concentrate 126, and the additive solution 128 in the mix chamber 138, and then delivered to the outlet 118. In yet another example, a user may request a third chemical solution 102 that is composed of a diluent fluid with a hydrogen peroxide component (referred to as a ‘peroxide diluent fluid’), a desired or selected cleaner concentrate 126, and/or a desired or selected additive solution 128. To prepare the third chemical solution 102, the peroxide diluent fluid 117, 121, which is generated by the electrolytic cell assembly 110 from one or more of the first fluid input source 108, the second fluid input source 112, and the third fluid input source 116, is mixed with the cleaner concentrate 126 and/or the additive solution 128 in the mix chamber 138, and then delivered to the outlet 118. It will be appreciated that many different chemical solutions 102 can be dispensed from the dispensing apparatus 104, and can include one or more inputs from the electrolytic cell assembly 110, the bypass line 114, or the cartridge system 120, or any combination of these components. For example, a diluent fluid 117, 119, 121 (modified or unmodified) may be mixed with a cleaner concentrate 126 with or without an additive solution 128. In some embodiments, a desired or selected diluent fluid (modified or unmodified) may be mixed with an additive solution 128 with or without a cleaner concentrate 126.

FIG. 2 illustrates a block diagram of an exemplary control system 140 associated with the dosing system 100. The control system 140 includes a controller 142 that is electrically or otherwise communicatively connected to modules or components of the dosing system 100. For example, the illustrated controller 142 is connected to the cell assembly 110, the pumps 130, the sensors 134, a user interface module 144, a power supply module 146, a communications module 148, and one or more valves or metering devices 150. In one construction, each of these components is supported on and coupled to the dispensing apparatus 104. In some constructions, one or more of these components may be separately supported.

The controller 142 can include any suitable combination of hardware and software that is operable to, among other things, control the operation of the dosing system 100. The exemplary controller 142 includes a plurality of electrical and electronic components that provide power, operational control and, in some cases, protection to the components and modules within the controller 142 and/or the dosing system 100. For example, the controller 142 can include, among other things, a processing unit 152 (e.g., a microprocessor, a microcontroller, or another suitable programmable device) and a memory 154, and in some embodiments can be implemented partially or entirely on a semiconductor (e.g., a field-programmable gate array (“FPGA”)) chip, such as a chip developed through a register transfer level (“RTL”) design process.

The memory 154 can include, for example, a program storage area and a data storage area. The program storage area and the data storage area can include one or more different types of memory, such as read-only memory (“ROM”), random access memory (“RAM”)(e.g., dynamic RAM (“DRAM”), synchronous DRAM (“SDRAM”), etc.), electrically erasable programmable read-only memory (“EEPROM”), flash memory, a hard disk, an SD card, or other suitable magnetic, optical, physical, or electronic memory device. The processing unit 152 can be connected to the memory 154 for execution of software instructions that are capable of being stored in a RAM of the memory 154 (e.g., during execution), a ROM of the memory 154 (e.g., on a more permanent basis), or another non-transitory computer readable medium such as another memory or a disc. Software included in some implementations of the dosing system 100 can be stored in the memory 154 of the controller 142, and can include, for example, firmware, one or more applications, program data, filters, rules, one or more program modules, and other executable instructions. In some embodiments, the controller 142 is configured to retrieve from memory and execute, among other things, instructions related to the control processes and methods described herein. As will be appreciated, the controller 142 can include additional, fewer, or different components.

The user interface module 144 controls or monitors aspects of the dosing system 100. For example, the user interface module 144 is operably coupled to the controller 142 to control operation of the dosing system 100, and can include input and output devices (e.g., digital input devices, digital output devices, analog input devices, analog output devices, or any combination of digital and analog input or output devices) that facilitate control and monitoring associated with the dosing system 100.

As illustrated, the user interface module 144 includes a display 156 (e.g., a primary display, a secondary display, etc.) and input devices 158 (e.g., a touch-screen display, a plurality of knobs, dials, switches, buttons, etc.). The display 156 can be, for example, a liquid crystal display (“LCD”), a light-emitting diode (“LED”) display, an organic LED (“OLED”) display, an electroluminescent display (“ELD”), a surface-conduction electron-emitter display (“SED”), a field emission display (“FED”), a thin-film transistor (“TFT”) LCD, or a reflective bistable cholesteric display (i.e., e-paper). The user interface module 144 also can be configured to display conditions or data associated with the dosing system 100 in real-time or substantially real-time. For example, the controller 142 can analyze one or more of the chemical cartridges 122 via one or more of the sensors 134 and determine, based on an analysis of the one or more cartridges 122, a status of the analyzed chemical cartridge(s) 122. The user interface module 144 can be configured to display the status as determined by the controller 142, including a concentrated solution level of one or more of the cartridges 122, a list of available chemical solutions 102 based on the fluid input sources 106 and the installed cartridges 122, available quantities of the available chemical solutions 102, and the like.

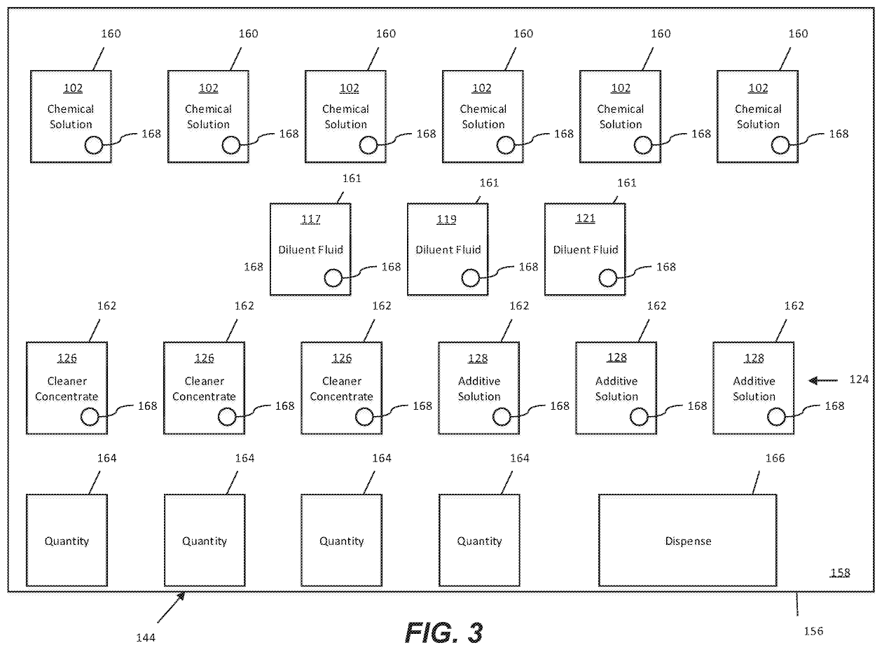

FIG. 3 schematically illustrates an exemplary user interface module 144 of the dosing system 100. A chemical solution 102 supported by the dosing system 100 can be requested or selected via the user interface module 144. The user interface module 144 includes product buttons or interfaces 160 that correspond to predefined chemical solutions 102 (e.g., comprised of one or more of the diluent fluids 117, 119, 121, or one or more diluent fluids 117, 119, 121 and one or more concentrated solutions 124). The product interfaces 160 are engageable by the user to select and request a chemical solution 102 to be prepared and dispensed by the dosing system 100. As illustrated, the user interface module 144 also includes buttons or interfaces 161 corresponding to particular diluent fluids 117, 119, 121, and buttons or interfaces 162 corresponding to particular concentrated solutions 124 (e.g., cleaner concentrates 126 and additive solutions 128) that are supported by the dosing system 100 and that can be mixed with each other. The interfaces 161, 162 are engageable by a user to select a desired chemical solution 102 that has properties different from the predefined chemical solutions 102. The user interface module 144 can further include quantity buttons or interfaces 164 corresponding to a desired quantity of chemical solution 102 to be dispensed, and a dispense button or interface 166 that can be engaged to initiate dispensation of a selected chemical solution 102.

Each of the chemical solution interfaces 160 and the interfaces 161, 162 includes a status indicator 168 that indicate a status associated with the respective interfaces and the corresponding selected chemical solution 102, the selected diluent fluid 117, 119, 121, and/or the selected concentrated solution 124. For example, the status indicator 168 may indicate that a particular chemical solution 102 is unavailable, or that the selected chemical solution 102 (or the selected diluent fluid 117, 119, 121, the selected concentrated solution 124, or both) is being dispensed or about to be dispensed (e.g., via color indicia, light indicia, etc., associated with the status indicator 168 for the selected interface(s)). The status indicator 168 may indicate an available quantity or remaining capacity of the selected chemical solution 102, the diluent fluid 117, 119, 121, or the concentrated solution 124.

The illustrated communications module 148 is configured to connect to and communicate with other devices (e.g., a computer, another dosing system or dispensing apparatus, etc.) through a network 170. The network 170 can be, for example, a wide area network (“WAN”) (e.g., a global positioning system (“GPS”), a TCP/IP based network, a cellular network, such as, for example, a Global System for Mobile Communications (“GSM”) network, a General Packet Radio Service (“GPRS”) network, a Code Division Multiple Access (“CDMA”) network, an Evolution-Data Optimized (“EV-DO”) network, an Enhanced Data Rates for GSM Evolution (“EDGE”) network, a 3GSM network, a 4GSM network, a Digital Enhanced Cordless Telecommunications (“DECT”) network, a Digital AMPS (“IS-136/TDMA”) network, or an Integrated Digital Enhanced Network (“iDEN”) network, etc.).

The network 170 can be a local area network (“LAN”), a neighborhood area network (“NAN”), a home area network (“HAN”), or personal area network (“PAN”) employing any of a variety of communications protocols, such as Wi-Fi, Bluetooth, ZigBee, etc. Communications through the network 170 by the communications module 148 or the controller 142 can be protected using one or more encryption techniques, such as those techniques provided in the IEEE 802.1 standard for port-based network security, pre-shared key, Extensible Authentication Protocol (“EAP”), Wired Equivalency Privacy (“WEP”), Temporal Key Integrity Protocol (“TKIP”), Wi-Fi Protected Access (“WPA”), and the like.

The connections between the communications module 148 and the network 170 can be, for example, wired connections, wireless connections, or any combination of wireless and wired connections. Similarly, the connections between the controller 142 and the network 170 or the communications module 148 are wired connections, wireless connections, or any combination of wireless and wired connections. In some embodiments, the controller 142 or communications module 148 includes one or more communications ports (e.g., Ethernet, serial advanced technology attachment (“SATA”), universal serial bus (“USB”), integrated drive electronics (“IDE”), CAN bus, etc.) for transferring, receiving, or storing data associated with the dosing system 100 or the operation of the dosing system 100.

The communications module 148 communicates, through the network 170, with a data system 172. The data system 172 can be one or a combination of a centrally located computer, a network of computers, and one or more centrally located servers, and functions to store, interpret, and communicate data to or from the dosing system 100. For example, the data system 172 can receive data from the dosing system 100 through the network 170, interpret the received data, and communicate the interpreted data to a user. Likewise, the data system 172 can receive requests or instructions from the user, and communicate the requests or instructions through the network 170 to the dosing system 100. More specifically, the dosing system 100 can track the amount of use via the sensors 134 and the controller 142, and communicate use information to the data system 172. The dosing system 100 can also communicate status information to the data system 172 including low or empty cartridges 122. In response, the data system 172 can activate an empty cartridge alarm and/or generate an empty cartridge pre-indication indicating that a cartridge is nearly empty (e.g., two days of chemical remaining based on estimated usage). In response to the empty cartridge pre-indication, the data system 172 can coordinate or facilitate ordering, shipment, and replacement of empty cartridges. In the same or other embodiments, the dosing system can communicate (e.g., via the communications module 148, the network 170, and/or the data system 172) with intelligent chemical solution containers located at the use location (e.g., intelligent spray bottles, intelligent cleaning machines, etc.; not shown) to determine existing supplies of chemical solutions 102 at the use location. Such inventory information can be communicated to the data system 172 as needed.

In operation of the dosing system 100, a user requests a chemical solution 102 to be prepared and dispensed by the dosing system 100 via the user interface module 144, and the request is communicated to the controller 142. Based on the request, the controller 142 instructs the dosing system 100 to mix a predetermined ratio of one or more of the diluent fluids 117, 119, 121 with one or more concentrated solutions 124 from the chemical cartridges 122 (e.g., via instructions sent to the pumps 130). When the chemical solution 102 has been mixed according to the request, the controller 142 instructs the dosing system 100 to dispense (e.g., via the outlet 118) a product with a dilution based on the selected chemical solution 102. The dilution dispensed by the dosing system 100 conforms to the request received by the user interface module 144. The number of different cartridges 122 containing concentrated solutions 124 and the number of different diluent fluids 117, 119, 121 that are available determines the flexibility of the dosing system 100 with regard to the number of different chemical solutions 102 that can be dispensed. As illustrated, the dosing system 100 is capable of producing a wide array of different chemical solutions 102 at the use location, including variations in the concentrations of chemical or additive in the dilution.

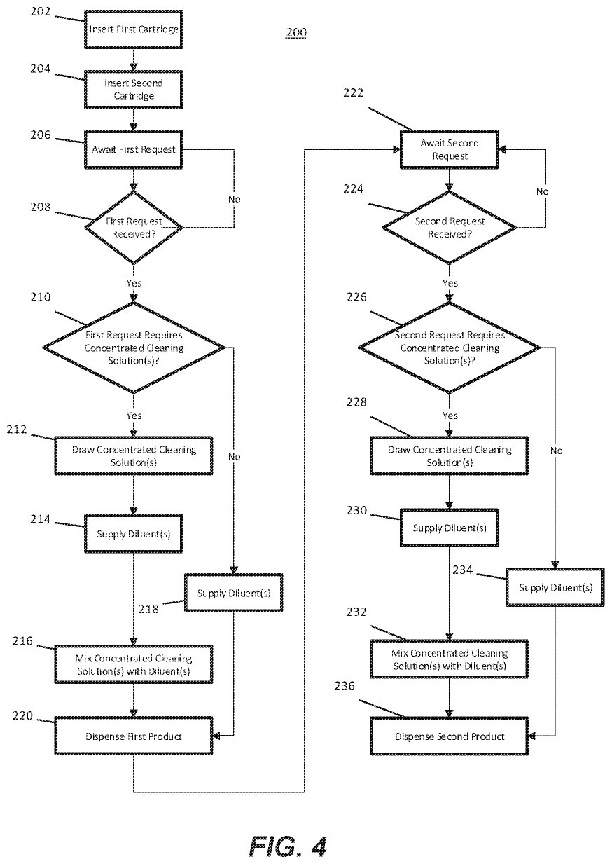

FIG. 4 illustrates a method 200 of dispensing a chemical solution 102 from the dosing system 100. The method 200 begins with removably inserting a first chemical cartridge 122 containing a first concentrated solution 124 into an installed position in the dosing system 100 (step 202). Next, the method 200 includes removably inserting a second cartridge 122 containing a second concentrated solution 124 into another installed position in the dosing system 100 (step 204), with the second concentrated solution 124 being different from the first concentrated solution 124. Additional cartridges 122 can be installed in the same manner. Following insertion of the available cartridges 122, the method 200 includes awaiting a first request for a chemical solution 102 (step 206). At step 208, the method 200 includes receiving, via the user interface module 144 of the dosing system 100, the first request for a first chemical solution 102 supported by the dosing system 100. Based on the first request, the dosing system 100 determines whether the first chemical solution 102 of the first request includes one or more concentrated solutions 124 (step 210). If concentrated solutions 124 are part of the first request, the method 200 next includes drawing concentrated solution 124 from the corresponding cartridge 122 (e.g., the first cartridge 122 or the second cartridge 122) based on the first request (step 212), supplying one of at least two different diluent fluids based on the first request (step 214), and mixing a predetermined ratio of the concentrated solution 124 drawn from the cartridge(s) 122 with the diluent fluid supplied based on the first request (step 216). If the first request does not include a concentrated solution 124, then steps 212, 214, and 216 are omitted, and the method 200 proceeds from step 210 to a step 218 of supplying one of at least two different diluent fluids by the dosing system 100 based on the first request. After step 216, or after step 218, as the case may be, the method 200 includes dispensing the first chemical solution 102 (e.g., a product) that has a first dilution including the drawn concentrated solution 124 and the supplied diluent fluid based on the first request (step 220). The first chemical solution 102 dispensed at step 220 conforms to the first request received by the user interface module 144.

After the first dilution is dispensed at step 220, the method 200 includes awaiting a second request for a chemical solution 102 (step 222). At step 224, the method 200 includes receiving, via the user interface module 144 of the dosing system 100, the second request for a second chemical solution 102 supported by the dosing system 100 (step 224). In this exemplary method, the second chemical solution 102 associated with the second request is different from the first chemical solution 102 associated with the first request received at step 208. Based on the second request, the dosing system 100 determines whether the second chemical solution 102 of the second request includes one or more concentrated solutions 124 (step 226). If concentrated solutions 124 are incorporated into the second chemical solution 102, the method 200 next includes drawing concentrated solution 124 from the at least one of the cartridges 122 based on the second request (step 228), supplying one of at least two different diluent fluids by the dosing system 100 based on the second request (step 230), and mixing a predetermined ratio of the concentrated solution 124 drawn from the first cartridge 122 or the second cartridge 122 with the diluent supplied based on the second request (step 232). If the second request does not include a concentrated solution 124, then steps 228, 230, and 232 are omitted, and the method 200 proceeds from step 226 to a step 234 of supplying one of at least two different diluents by the dosing system 100 based at least in part on the second request. After step 232, or after step 234, as the case may be, the method 200 includes dispensing the second chemical solution 102 (i.e. product) that has a second dilution including the drawn concentrated solution 124 and the supplied diluent fluid based on the second request (step 236). The second chemical solution 102 dispensed at step 236 conforms to the second request received by the user interface module 144.

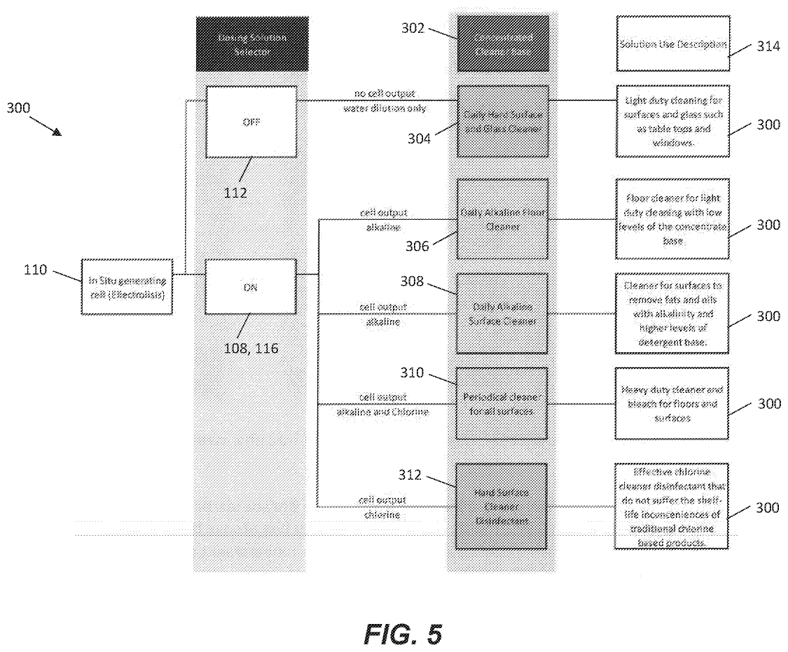

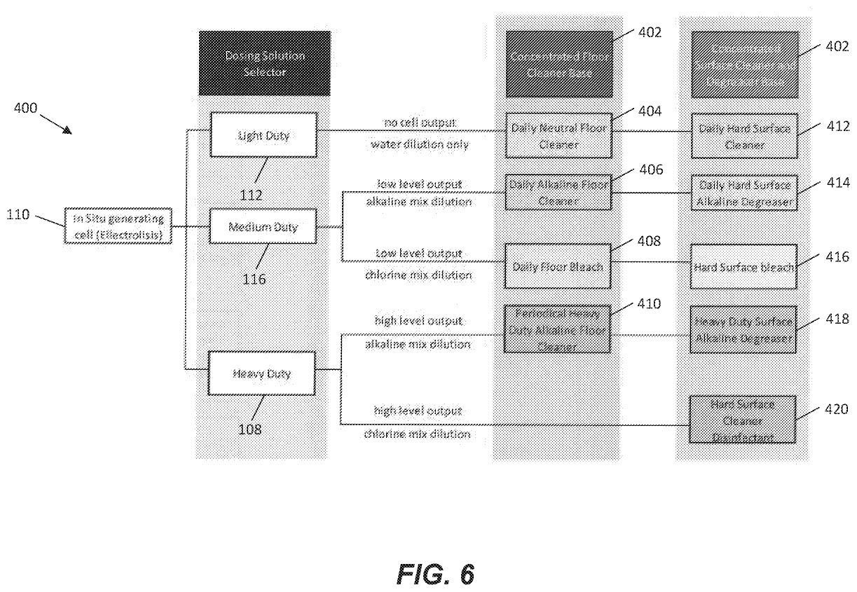

With reference to FIG. 1 in the context of FIGS. 5 and 6, the diluents supplied by the fluid input sources 106 are delivered to or bypass the cell assembly 110. The cell assembly 110 processes or modifies the diluents to produce diluent fluids that have different cleaning applications or capacities. For example, the cell assembly 110 can modify the first diluent or the second diluent to have relatively high concentrations of an alkaline component and a chlorine component, (e.g., to produce a heavy-duty cleaning fluid). In another example, the cell assembly 110 can modify the first diluent or the second diluent to have relatively low concentrations of an alkaline component and a chlorine component (e.g., to produce a medium-duty cleaning fluid). In yet another example, the cell assembly 110 can modify the first diluent or the second diluent to have only an alkaline component or a chlorine component (e.g., to produce a light duty cleaning fluid). In another example, the cell assembly 110 can modify the first diluent or the second diluent to generate a peroxide diluent fluid, which can be chemically activated by adding a concentrated acid (e.g., organic) or a surfactant, or acetic acid (to produce peracetic acid) for high demand disinfection applications or in situ sporicidal disinfection solutions. In still another example, and with particular reference to FIG. 6, diluent from the second fluid input source 112 can flow through the cell assembly 110 without being processed or modified (e.g., to provide a light-duty cleaning fluid). Each of the fluids that are processed by or that simply flow through or bypass the cell assembly 110 are mixed, as selected, with concentrated solutions 124 to produce the desired cleaning fluid.

FIG. 5 is a diagram 300 illustrating exemplary chemical solutions 302 that can be prepared and dispensed by the dosing system 100, together with a use description 314 for each exemplary chemical solution 302. The chemical solutions 302 shown in FIG. 5 are intended to be exemplary and should in no way limit the number or type of chemical solutions 102 that the dosing system 100 is capable of producing. The exemplary chemical solutions 302 differ according to the diluent fluids 117, 119, 121 available in the system 100. More specifically, the exemplary chemical solutions 302 include cleaning products 304 that are prepared from the diluent fluid 119 that is supplied from the second fluid input source 112 and that flows through the cell assembly 110 (or that bypasses the assembly 110) without being modified. The illustrated exemplary chemical solutions 302 also include cleaning products 306-312 that are prepared from diluent fluids 117, 121 that are processed by the electrolytic cell assembly 110 and that have different amounts or concentrations of an alkaline component, a chlorine component, or both, or different amounts or concentrations of activated hydrogen peroxide. Each of the cleaning products 304-312 includes a corresponding use 316-324 as detailed in FIG. 5.

FIG. 6 is another diagram 400 illustrating exemplary chemical solutions 402 that can be prepared and dispensed by the dosing system 100. The chemical solutions 402 shown in FIG. 6 are intended to be exemplary and should in no way limit the number or type of chemical solutions 102 that the dosing system 100 is capable of producing. The diagram 400 differs from the diagram 300 discussed with regard to FIG. 5 by further differentiating the diluent fluids 117, 119, 121 that are supplied by the system 100 and that are modified or unmodified by the cell assembly 110 to produce a heavy-duty cleaning fluid, a medium-duty cleaning fluid, or a medium-duty cleaning fluid when mixed with concentrated solution(s) 124. As shown in FIG. 6, the exemplary chemical solutions 402 include cleaning products 404-420.

With regard to the examples described herein including hydrogen peroxide that is generated by the cell assembly 110, the chemical solutions 102 that are mixed with a cleaner concentrate 126 activates the hydrogen peroxide to boost the disinfection efficacy of the hydrogen peroxide. Activator compositions for hydrogen peroxide are application-related and can include a surfactant, an acid, or combinations of surfactant and acid. It will be appreciated that the system is not limited to these components. Generation of hydrogen peroxide by the cell assembly 110 avoids the formulation challenge associated with conventional fully-formulated products where immiscible components like hydrogen peroxide (polar in nature) and surfactants and/or acids (apolar in nature) need to be combined in one product. Conventional products therefore require significant levels of water, solvents, and emulsifiers to combine these materials into one product. The apolar hydrogen peroxide cleaning fluid is generated by the dispensing apparatus 104, which allows chemical solutions 102 to be made that are organic/apolar in nature and can be approximately 100% active without water, solvents, or emulsifiers. The advantages of on-site generation of a hydrogen peroxide-based chemical solution include, among others, a reduction in packaging waste and carbon footprint, and generation of accurate concentrations of cleaning fluid for the task at hand.

More generally, the electrolyzed fluid produced by the electrolytic cell assembly 110, without addition of further chemistry, makes it possible to clean lightly soiled sanitary and other surfaces. The electrolyzed fluid that includes cleaner concentrate 126 and/or an additive solution 128 provides a stronger disinfection and cleaning solution. Each can be tailored by the dispensing apparatus 104 to the specific cleaning to be done.

Although the invention has been described in detail with reference to certain preferred embodiments, variations and modifications exist within the scope and spirit of one or more independent aspects of the invention as described.

1. A dosing system comprising:
a dispensing apparatus configured to receive a first fluid via a first fluid input source and a second fluid via a second fluid input source, the first fluid configured to be modified by an electrolytic cell assembly to produce an output fluid comprising one or more of an alkaline component, a chlorine component, and a hydrogen peroxide component, and the second fluid configured to flow through the electrolytic cell assembly or bypass the electrolytic cell assembly, the dispensing apparatus including:
a cartridge system configured to removably support a plurality of chemical cartridges, each chemical cartridge including a concentrated solution and a mechanism configured to dispense the concentrated solution contained in the chemical cartridge, at least two of the plurality of chemical cartridges including different concentrated solutions, and each chemical cartridge is in selective fluid communication with one or both of the output fluid and the second fluid;
an interface configured to receive a request for a chemical solution supported by the dosing system;
a controller including a processor programmed to perform instructions stored in a memory, the instructions including
receiving the request from the interface;
mixing a predetermined ratio of at least one of the concentrated solutions from the chemical cartridges and one or both of the output fluid and the second fluid; and
dispensing a product defining a dilution including one or both of the output fluid and the second fluid and one or more of the chemical solutions supported by the chemical cartridges, the dilution conforming to the request received by the interface.

2. The dosing system of claim 1, wherein the concentrated solution includes a cleaner concentrate or an additive solution.

3. The dosing system of claim 1, wherein the second fluid is water.

4. The dosing system of claim 1, wherein the dilution includes two or more of the concentrated solutions.

5. The dosing system of claim 1, wherein the output fluid is a first output fluid, wherein the dispensing apparatus is further configured to receive a third fluid via a third fluid input source, wherein the third fluid is configured to be modified by the electrolytic cell assembly to produce a second output fluid, and wherein the third fluid is different from the first fluid and the second fluid.

6. The dosing system of claim 5, wherein the first output fluid includes a medium-duty cleaning fluid, and wherein the second output fluid includes a heavy-duty cleaning fluid.

7. The dosing system of claim 6, wherein each of the first output fluid, the second output fluid, and the second fluid are configured to flow from the electrolytic cell assembly.

8. The dosing system of claim 7, wherein the second fluid is water.

9. The dosing system of claim 1, wherein the instructions further include analyzing one or more of the chemical cartridges via one or more sensors, and determining based on the analysis a status of the analyzed chemical cartridges.

10. The dosing system of claim 9, wherein the status includes one or more of:
a presence of concentrated solution within the analyzed chemical cartridge,
an absence of concentrated solution within the analyzed chemical cartridge, and
a concentrated solution level within the analyzed chemical cartridge; and
wherein in response to the status, the instructions further include one or more of;
initiating an empty cartridge alarm, and
initiating an empty cartridge pre-indication that initiates ordering of a replacement chemical cartridge.

11. The dosing system of claim 1, wherein the dilution includes activated hydrogen peroxide.

12. A method of dispensing a chemical product from a dosing system, the method comprising:
removably inserting a first cartridge containing a first concentrated solution into an installed position in the dosing system;
removably inserting a second cartridge containing a second concentrated solution into another installed position in the dosing system, the second concentrated solution being different from the first concentrated solution;
receiving, via a user interface of the dosing system, a first request for a first chemical solution supported by the dosing system;
drawing concentrated solution from the first cartridge or the second cartridge based at least in part on the first request;
supplying one of at least two different diluents by the dosing system based at least in part on the first request;
mixing a predetermined ratio of the concentrated solution drawn from the first cartridge or the second cartridge with the diluent supplied based at least in part on the first request;
dispensing a first product defining a first dilution including the drawn concentrated solution and the supplied diluent based at least in part on the first request, wherein the first dilution conforms to the first request received by the interface;
receiving, via the user interface of the dosing system, a second request for a second chemical solution supported by the dosing system, the second chemical solution being different from the first chemical solution;
drawing concentrated solution from the first cartridge or the second cartridge based at least in part on the second request;
supplying one of the at least two different diluents by the dosing system based at least in part on the second request;
mixing a predetermined ratio of the concentrated solution drawn from the first cartridge or the second cartridge with the diluent supplied based at least in part on the second request; and
dispensing a second product defining a second dilution including the drawn concentrated solution and the supplied diluent based at least in part on the second request, wherein the second dilution conforms to the second request received by the interface.

13. The method of claim 12, further comprising electrolyzing the supplied diluent prior to mixing with the concentrated solution.

14. A dosing system comprising:
a dispensing apparatus configured to receive a first fluid via a first fluid input source and a second fluid via a second fluid input source, the first fluid configured to be modified by an electrolytic cell assembly to produce an output fluid comprising one or more of an alkaline component, a chlorine component, and a hydrogen peroxide component, and the second fluid configured to flow through the electrolytic cell assembly or bypass the electrolytic cell assembly, the dispensing apparatus including:
a cartridge system configured to support a plurality of chemical cartridges, each chemical cartridge including a concentrated solution, at least two of the plurality of chemical cartridges including different concentrated solutions, and each chemical cartridge in selective fluid communication with one or more of the output fluid and the second fluid via a mix chamber;
an interface configured to receive a request for a chemical solution supported by the dosing system;
a controller including a processor programmed to perform instructions stored in a memory, the instructions including
receiving the request from the interface;
mixing a predetermined ratio of one or more of the concentrated solutions from the chemical cartridges and one or more of the output fluid and the second fluid; and
dispensing a product conforming to the request received by the interface,
wherein the dispensed product defines a dilution that includes one of a first concentration of chemical solution and a second concentration of chemical solution having a higher concentration than the first concentration of chemical solution.

15. The dosing system of claim 14, wherein the concentrated solution includes a cleaner concentrate or an additive solution.

16. The dosing system of claim 14, wherein the second fluid is water, and wherein the first fluid is water prior to being modified by the electrolytic cell assembly.

17. The dosing system of claim 14, wherein the dilution includes two or more of the concentrated solutions.

18. The dosing system of claim 14, wherein the output fluid is a first output fluid, wherein the dispensing apparatus is configured to receive a third fluid via a third fluid input source, wherein the third fluid is configured to be modified by the electrolytic cell assembly to produce a second output fluid, and wherein the second output fluid is different from the first output fluid and the second fluid.

19. The dosing system of claim 18, wherein the first output fluid includes a medium-duty cleaning fluid, and wherein the second output fluid includes a heavy-duty cleaning fluid.

20. The dosing system of claim 19, wherein each of the first output fluid, the second output fluid, and the second fluid are configured to flow from the electrolytic cell assembly.

21. The dosing system of claim 14, wherein the instructions further include analyzing one or more of the chemical cartridges via one or more sensors, and determining, based on an analysis of the one or more chemical cartridges, a status of the analyzed chemical cartridges.

22. The dosing system of claim 21, wherein the status includes one or more of:
a presence of concentrated solution within the analyzed chemical cartridge,
an absence of concentrated solution within the analyzed chemical cartridge, and
a concentrated solution level within the analyzed chemical cartridge; and
wherein in response to the status, the instructions further include one or more of;
initiating an empty cartridge alarm, and
initiating an empty cartridge pre-indication that initiates ordering of a replacement chemical cartridge.

23. The dosing system of claim 14, wherein the dilution includes activated hydrogen peroxide.
